(19) United States
(12) Patent Application Publication
(10) Pub. No.: US 2026/0347683 A1
(43) Pub. Date: Nov. 5, 2026

(54) Method of Forming Gels in a Well or Subterranean Formation In-Situ

(71) Applicant: Baker Hughes Oilfield Operations LLC, Houston, TX (US)

(72) Inventors: Radhika Suresh, Sugar Land, TX (US); Oleg A. Mazyar, Katy, TX (US); Rostyslav Dolog, Houston, TX (US); Angela Anh Doan, Spring, TX (US); Naima Bestaoui-Spurr, The Woodlands, TX (US); Hoi Yen Leung, Missouri City, TX (US)

(21) Appl. No.: 19/193,178

(22) Filed: Apr. 29, 2025

(51) Int. Cl. C09K 8/514; C09K 8/516; E21B 33/138

(52) U.S. Cl. CPC C09K 8/514; C09K 8/516; E21B 33/138; C09K 2208/10

(57) ABSTRACT

An aqueous fluid is used to create a temporary plug in a subterranean formation. The aqueous fluid contains negatively charged cellulosic nanocrystal(s) and a quaternary amine or a nitrogen component which, when protonated, reacts with the cellulosic nanocrystal(s) to form the plug. The fluid may also contain a carbon dioxide source. Once the plug is formed, fluid flow from a more permeable zone of a formation may be directed to a less permeable zone.

### FIELD

The disclosure relates to a method of treating an oil, gas or geothermal well by forming in-situ a temporary gel or plug. The fluid may be used to temporarily isolate targeted zones in the well by creating a temporary seal or plug when the fluid is gelled in-situ. The temporary seal or plug renders an impermeable barrier to flow of fluids into the targeted zone. The fluid is particularly useful in stimulation, drilling, completion and cementing operations.

### BACKGROUND

Aqueous based well treatment fluids are commonly used in drilling, stimulation, completion and cementing operations of subterranean formations. A problem which occurs in the field is the loss of such fluids into highly permeable zones or in natural fractures of the formation or into the wellbore.

Loss of circulation fluids into the formation or wellbore can dramatically increase the costs of such operations. During drilling and completion operations, such fluid loss often results in damage to the drill bit caused by overheating, a decrease in the drilling rate as well as blowout due to a drop in fluid level in the well. In some instances, loss of circulation fluids may cause the collapse of the formation at the wellbore as well as in-depth plugging of the formation. This, in turn, may cause such extensive damage that the reservoir may have to be abandoned.

In order to stop or retard the loss of circulation fluids, it is desirable to quickly plug flow passages responsible for such losses. Often, lost circulation materials (LCMs) which are capable of bridging or blocking seepage into the formation are added to the fluid. Unfortunately, flow properties of most LCMs do not achieve effective plugging. This may be particularly problematic during treatment of elevated temperature and/or high pressure wells.

In well stimulation operations, such as hydraulic fracturing, acid stimulation, steam injection and thermal injection, recovery efficiency of hydrocarbon fluids in the formation may be limited by flow mechanisms associated with zones of low permeability in the formation. Typically, fluids produced during stimulation operations may be recovered from a multiplicity of producing zones within the reservoir. Such zones typically exhibit varying levels of permeability. At times, it is desirable to seal off a zone of higher permeability in order to produce fluids from a plugged-off zone or lower permeability zone within the reservoir. Further, it may be desirable to temporarily isolate a high permeability zone in order to produce fluids from that targeted zone. Such methods of selective stimulation become more important as the life of the well declines and productivity of the well decreases.

Diverting chemical systems provide a temporary barrier for entry of treatment fluids into zones of higher permeability. Selective isolation of targeted productive intervals within the well has been effectuated by the use of polymeric gels capable of temporarily sealing a zone of interest from other zones. For instance, U.S. Pat. No. 8,636,066 discloses use of a borated galactomannan gum as a temporary sealant. Such systems enable production from less permeability zones by diverting flow from the blocked higher permeability zone to the zone of lower permeability. See also, U.S. Pat. Nos. 9,919,966; 9,920,610; 10,041,327; and 10,988,678.

Gellant systems for use in zonal isolation and as diverting agents often exhibit multiple drawbacks. For instance, temporary plugs are typically only effective over a relatively brief period of time. Further, such systems are often ineffective in sealing productive zones at elevated bottomhole temperatures. This is particularly the case in the harvesting or recovery of thermal energy from a thermally productive formation where an aqueous based system is pumped deep into an elevated temperature geothermal well in order to recover heat. The recovered heat energy may be used to drive turbines as well as generate electrical power. Recovery of heat from a geothermal well is normally maximized by targeting more productive zones by sealing off less productive zones. Temporary seals for this purpose must be capable of withstanding the elevated temperatures encountered in the geothermal well.

Alternative fluids and systems functioning as LCMs and alternative gellant systems for use as diversion and zonal isolation fluids as well as for use in the recovery of thermal energy have therefore been sought.

It should be understood that the above-described discussion is provided for illustrative purposes only and is not intended to limit the scope or subject matter of the appended claims or those of any related patent application or patent.

### SUMMARY

An aqueous fluid is provided for sealing selected zones within a formation penetrated by a well. The aqueous fluid may be used to direct fluid flow from a more permeable zone of a formation to a less permeable zone. In an embodiment, the system may be used in a stimulation operation, such as a hydraulic fracturing, acid fracturing, acidizing operation and re-fracturing by temporarily blocking a productive zone. In another embodiment, the system may be used as a temporary seal to effectuate zonal isolation between intervals of a wellbore for selected treatment of productive (or previously producing intervals) in multiple interval wellbores. The system may also be used to prevent loss of circulation fluids during well drilling, completion and workover operations.

In an embodiment, a method of enhancing productivity from a subterranean formation penetrated by a well is provided by forming a gel in-situ from a negatively charged component and a quaternary amine or a protonated nitrogen component. Protonation of the nitrogen component may occur in-situ. The gel is formed when the quaternary amine or protonated nitrogen component reacts with the negatively charged component.

In an embodiment, the quaternary amine may be pumped into the well in a fluid. In another embodiment, the protonated nitrogen component may be formed on the surface and then pumped into the well in a fluid. In another embodiment, the nitrogen component may be protonated with a proton which forms during dissociation of water. Such self-protonation doesn't require any external agent.

In another embodiment, the nitrogen component may be protonated in-situ from the proton generated by the reaction of carbon dioxide with water. In addition, reaction of carbon dioxide with an amine may form the proton as well as a carbamate in-situ. The carbon dioxide may be generated in the well or carbon dioxide may be pumped into the well, optionally as a component of the fluid.

In an embodiment, a method of enhancing productivity from a subterranean formation penetrated by a well is provided by forming a gel in-situ from a negatively charged component and a quaternary amine or a protonated nitrogen component. The nitrogen component may be protonated in-situ. The quaternary amine or protonated amine reacts with the negatively charged component to form a gel.

In an embodiment, the nitrogen component may be selected from a quaternary amine, an organic amine compound and polymers, amine functionalized nanoparticles and polyamino nanoparticles as well as mixtures thereof.

In an embodiment, the negatively charged component may be a negatively charged cellulosic nanocrystal.

In another embodiment, the negatively charged component maybe generated in-situ from a carbonate salt. The carbonate salt may be pumped into the well or produced in the well.

In an embodiment, a method of enhancing productivity from a subterranean formation is provided wherein a gel is formed in-situ or a formed gel is strengthened by the interaction of a protonated amine and a carbamate produced from a carbonate salt.

In another embodiment, a method of stimulating a subterranean formation is provided wherein an aqueous fluid comprising negatively charged cellulosic nanocrystals and a nitrogen containing component is introduced into a well. The nitrogen containing component may be a quaternary amine or an amine protonated on the surface. The protonated nitrogen containing component may further be generated in-situ and be reactive with the negatively charged cellulosic nanocrystals to form the gel. The gel forms a plug or fluid impermeable barrier in a targeted zone within the formation. One or more aqueous fluids are then pumped into the well. Flow of these fluids are diverted from the targeted zone to one or more second zones; the permeability of the targeted zone being higher than the permeability of the one or more second zones.

In another embodiment, a gel formed from the interaction of a negatively charged component and quaternary amine or protonated nitrogen component may be strengthened by formation of carbamates generated in-situ which are reactive also with the protonated nitrogen component or quaternary amine.

Accordingly, the present disclosure includes features and advantages which are believed to enable it to advance downhole technology. Characteristics and advantages of the present disclosure described above and additional features and benefits will be readily apparent to those skilled in the art upon consideration of the following detailed description of various embodiments and referring to the accompanying drawings.

### DRAWINGS

The following figures are part of the present specification, included to demonstrate certain aspects of various embodiments of this disclosure and referenced in the detailed description herein:

FIG. 1 illustrates the gel strength in a reversible gel obtained by reaction of cellulosic nanocrystals modified with sulfonate groups and poly(diallyldimethylammonium chloride).

FIG. 2 illustrates the gel strength in a reversible gel obtained by reaction of cellulosic nanocrystals modified with sulfonate groups and aminated nanoparticles.

### DETAILED DESCRIPTION

Characteristics and advantages of the present disclosure and additional features and benefits will be readily apparent to those skilled in the art upon consideration of the following detailed description. It should be understood that the description herein, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to.” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

All ranges disclosed herein are inclusive of the endpoints. A numerical range having a lower endpoint and an upper endpoint shall further encompass any number and any range falling between the lower endpoint and the upper endpoint. For example, every range of values (in the form “from a to b” or “from about a to about b” or “from about a to b,” “from approximately a to b,” “between about a and about b,” and any similar expressions, where “a” and “b” represent numerical values of degree or measurement is to be understood to set forth every number and range encompassed within the broader range of values and inclusive of the endpoints.

Zones within a formation may be sealed with a gel. The gel is formed in-situ from a negatively charged component and a quaternary amine or protonated nitrogen component. The protonated nitrogen component may be formed in-situ or it may be pumped into the formation. The quaternary amine or protonated nitrogen component reacts downhole with the negatively charged component to form the gel.

In an embodiment, the aqueous fluid used in the disclosed methods contains (i) negatively charged cellulosic nanocrystal(s); and (ii) a quaternary amine or a nitrogen component which, when protonated, reacts with the cellulosic nanocrystal(s). The fluid may further contain a carbon dioxide source. Alternatively, carbon dioxide may be pumped into the reservoir, typically contemporaneous or subsequent to the addition of the cellulosic nanocrystal(s) and nitrogen component.

The negatively charged component may be anionic cellulosic nanocrystal(s) (CNC) which may encompass cellulose crystallites, nanocelluloses, cellulose nanowhiskers, cellulose whiskers, cellulose nanoparticles, cellulose nanowires, nanocrystalline celluloses (NCCs), cellulose nanocrystals, etc.

The concentration of negatively charged component(s) in the aqueous fluid may be greater than 0.5% (about 41.7 pptg) by weight based on the total weight of the aqueous fluid. In an embodiment, the concentration of negatively charged component(s) in the aqueous fluid can range from about 0.25% to about 60% (about 21 pounds per thousand gallons (pptg)) to about 5,004 pptg), preferably from about 2% to about 20% by weight (about 167 pptg to about 1670 pptg) and in some instances about 0.5% by weight (about 42 pptg).

In an embodiment, the dimensions of the CNCs may be in the range from about 3 to about 50 nm in diameter width and from about 50 to about 500 nm in length and, in some cases, may be up to several micrometers in length. In some instances, the degree of polymerization of cellobiose units may be as high as 20,000. Typically, for wood-derived cellulosic materials, the number of units is approximately 10,000 and the number of units for cotton-derived celluloses is about 15,000.

Suitable negatively charged cellulosic components are anionic carboxymethyl cellulose. Further suitable cellulosic materials include those derivatized by treatment of native cellulosic fibers by acid hydrolysis. Such cellulosic materials may have surface sulfonate, phosphate, and/or carboxylate groups (shown below as a, c and e, respectively) as well as sulfate groups:

Methods of derivatizing cellulosic materials may proceed by methods known in the art. For instance, (a) showing a cellulosic material modified with a sulfonate group may be obtained, for instance, by acid hydrolysis of native cellulosic fibers with sulfuric acid under controlled temperatures, generally from room temperature to 70 °C while (c) showing a cellulosic material modified with a phosphate group may be obtained, for instance, by acid hydrolysis of native cellulosic fibers with phosphoric acid under controlled temperatures, generally from room temperature to 70 °C. Further, an exemplary oxidized cellulosic material containing a carboxylate group may be illustrated as (e). Oxidized cellulosic materials may be obtained using 2,2,6,6-tetramethylpiperidin-1-yl) oxyl (TEMPO) with sodium hydroxide and sodium chlorate. Derivatization may enhance the dispersibility and reactivity of the anionic cellulosic material.

In another preferred embodiment, the negatively charged cellulosic nanocrystal may be a negatively charged sulfate half-ester group.

Negatively charged nanocrystals may further be derivatized to include a variety of functional groups such as, for example, carboxy (e.g., carboxylic acid and anhydride groups like maleic anhydride), epoxy, ether, ketone, hydroxy, alkoxy, alkyl, aryl, aralkyl, alkaryl and lactone. In an embodiment, the negatively charged cellulosic nanocrystals in the fluid may include a variety of derivatized moieties as well as underivatized nanoparticles.

The nanocrystals may further be derivatized to include one or more functional groups that are hydrophilic, hydrophobic, oxophilic, lipophilic, oleophobic, or oleophilic or a mixture thereof. In an embodiment, such functional groups may include (i) organosilicon materials, (ii) fluorinated organic acids or a reactive derivative; (iii) linear or branched alkyl organic acids or a reactive derivative, (iv) substituted alkyl organic acids or a reactive derivative, (v) aryl or substituted aryl organic acids or a reactive derivative as well as (vi) mixtures thereof.

In an embodiment, the negatively charged nanoparticles may be derivatized with an organic acid having a long chain alkyl, aryl or fluoro groups. Suitable organic acids include carboxylic acids, sulfonic acids, phosphoric acids, phosphonic acids and phosphinic acids.

Exemplary carboxylic acids include those of the formula R—COOH where R is a linear or branched C₉-C₂₄, preferably C₁₂-C₂₁ hydrocarbon group or a hydroxylated derivative thereof or a C₆-C₂₀ aryl, alkylaryl or arylalkyl group. Suitable carboxylic acids include behenic acid, palmitic acid, etc. In an embodiment, the organic acid of the hydrophobic and/or oleophobic has two or more carboxylic acid moieties and preferably wherein the number average molecular weight of the organic acid is between from about 80 g/mol to about 2,000 g/mol.

Suitable reactive functional groups of organic acids include acid chlorides such as those of the formula R′(C═O)Cl, esters such as those of the formula R′—COOR″ and corresponding acid anhydrides. In an embodiment R′ and R″ may be a C₁-C₈ hydrocarbon group or R as defined above.

The nanoparticles which may be functionalized to include amine groups typically have a number average particle size suitable for rendering the gelled fluid. For example, the nanoparticles may be less than 2,000 nm in diameter, typically less than 1,000 nm and preferably to about 500 nm in diameter, more preferably from about 5 to about 250 om, often from about 5 to about 100 nm, 5 to about 50 nm, or about 1 nm to about 25 nm in diameter. In an embodiment, the nanoparticles referenced herein may be any geometric shape, such as tubular, spherical, etc.

Some of the nanoparticles may be neutral or negatively charged before functionalized with amino groups.

Suitable nanoparticles which may be derivatized include nanotubes, nanographite, nanodots, nanorods and nanodiamonds. Nanoparticles which may be derivatized include fullerenes and graphenes.

Fullerenes include cage-like hollow polyhedral allotropic carbon forms possessing a polyhedral structure and include those having from about 20 to about 100 carbon atoms.

Nanographites may be represented as clusters of plate-like sheets of graphite having a stacked structure of one or more layers of graphite of plate-like two-dimensional structures of fused hexagonal rings.

Suitable graphenes including nanographene and graphene fibers (graphene particles having an average largest dimension of greater than 1 μm, a second dimension of less than 1 μm, and an aspect ratio of greater than 10, where the graphene particles form an interbonded chain). The graphene and nanographene fibers are effectively two-dimensional particles having more than one layer of fused hexagonal rings. Typically, the graphene nanoparticles may be prepared by exfoliation of a graphite source such as nanographite, graphene or nanographene, graphene oxide, graphite and intercalated graphite. Exemplary exfoliation methods include fluorination, acid intercalation as well as acid intercalation followed by elevated temperature treatment Exfoliation of the nanographite provides a nanographene having fewer layers than non-exfoliated nanographite. Exfoliation of nanographite may provide the nanographene as a single sheet only one molecule thick, or as a layered stack of sheets. In an embodiment, the exfoliated nanographene may have fewer than 50 single sheet layers and in another embodiment fewer than 5 single sheet layers.

Suitable nanotubes include carbon nanotubes, inorganic nanotubes (e.g., boron nitride nanotubes), metallated nanotubes or a combination thereof. Suitable nanotubes include single walled nanotubes (SWNTs) or multi-walled nanotubes (MWNTs).

Suitable polysilsesquioxanes (also referred to as polyorganosilsesquioxanes or polyhedral oligomeric silsesquioxanes (POSS) derivatives) are polyorganosilicon oxide compounds of general formula RSiO_{1.5} (where R is an organic group such as methyl) having defined closed or open cage structures (closo or nido structures). Polysilsesquioxanes, including POSS structures may be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

In addition, the nanoparticles may be nano-layered silicates or nanoclays (hydrated or anhydrous silicate, plate-like minerals with a layered structure). Exemplary nanoclays include aluminosilicate clays like kaolins (including vermiculite), hallyosite, bentonite, smectites (including montmorillonite), saponite, beidellite, nontrite, hectorite, alllophane and illite as well as titanium sulfate, zirconium phosphate, titanium phosphate and zirconium sulfate. The nanoclays may be exfoliated to separate individual sheets, or non-exfoliated. Other nanosized mineral fillers of similar structure which may be used include talc, micas including muscovite, phlogopite or phengite. Platelets of some nanoclays may have a thickness of about 3 to about 1000 Angstroms, a size in the planar direction ranging from about 0.01 μm to 100 μm, a specific surface area in from about 5 to about 800 m²/g and an aspect ratio (length versus thickness) in the order of about 10 to about 10,000. Nanoparticles of exfoliated clays may exhibit a surface area from 2505 to 28,000 cm²/g and a mean particle diameter (D₅₀) from about 40 to about 15.

Nanoparticles referenced herein may also be derivatized and include inorganic nanoparticles such as a metal or metalloid oxide or hydroxide like silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide, zinc oxide, iron oxide, silica, aluminum oxide, antimony oxide, vanadium oxide as well as magnesium oxide and metal or metalloid carbides and nitrides like tungsten carbide, silicon carbide, and boron carbide and metal or metalloid nitrides like titanium nitride, boron nitride, carbon nitride and silicon nitride or a combination thereof. Metal nanoparticles include alkali metals, alkaline earth metals, inner transition metals (a lanthanide or actinide), a transition metal, or a post-transition metal. Examples of such metals include magnesium, aluminum, iron, tin, titanium, platinum, palladium, cobalt, nickel, vanadium, chromium, manganese, zirconium, ruthenium, hafnium, tantalum, tungsten, rhenium, osmium, alloys thereof as well as barium or strontium titanate or a combination thereof. Preferred nanoparticles include alumina, boehmite and zirconia.

In addition, other nano-sized particles may be functionalized with quaternary amino groups including, but not limited to, polysilsesquioxanes, hydroxyapatite and clay.

In addition to the amine derivatized nanoparticles, amine compounds and amine polymers may be protonated for reaction with the negatively charged cellulosic nanocrystals.

Suitable nitrogen components for protonation include amine compounds or amine polymers, such as imidazole, ethanolamine, isopropylamine, triethylamine, diethylamine, diisopropylamine, dipropylamine, N,N-diisopropyethylamine, trimethylamine hydrochloride, methylamine hydrochloride, n-hexylamine, n-octylamine, n-hexyldecylamine, oleylamine, 4-aminophenol, 1,2-phenylenediamine, 1,4-phenylenediamine, N,N,N′,N′,N″-pentamethyldiethylenetriamine, N,N,N′,N′-tetramethylethylenediamine, ethylene diamine, bis(3-aminopropyl)amine, 1,3-diaminopropane, hexamethylenediamine.

More preferred nitrogen containing components are polyvinyl amines, polylysine, poly(L-lysine hydrobromide), poly(N-isopropylacrylanide), chitosan, poly(4-aminosytrene), poly(N-methylvinylamine), poly(ethylene glycol)bis(2-aminoethyl), poly(2-vinyl-1-methylpyridinium bromide), poly(vinylamine) hydrochloride, polyethyleneimine, polyallylamines, polyethylene amines, polyethylene glycol amines, polyether amines, polyamine compounds having from 2 or more nitrogen groups such as those of the formula H₂NCH₂[(CH₂)ₙNH]ₘCH₂NH₂ wherein n and m are independently selected from 2 to 24, and epoxidized amines containing three to six carbon atoms. In a preferred embodiment, the nitrogen containing component is a polyethyleneimine including those commercially available as EPOMIN® from Molecule Enterprise Co., Ltd. which made from ring opening polymerization of ethyleneimine.

Other suitable amine polymers include poly(allylamine hydrochloride), poly(allylamine), poly(diallylmethyl ammonium chloride), as well as copolymers of an acrylamide unit and a diallyldimethylammonium salt and, optionally, an acrylic acid or a salt thereof.

In an exemplary embodiment, any of the nanoparticles referenced above may be derivatized by amination to include amine groups, where amination may be accomplished by nitration followed by reduction, or by nucleophilic substitution of a leaving group by an amine, substituted amine, or protected amine, followed by deprotection, as necessary.

Other suitable nitrogen components include guanidine and guanidine derivatives as well as any of the amine compounds/polymers referenced herein containing a guanidine functional group or a guanidine derivative functional group. In an embodiment, any of the nanoparticles referenced herein may be derivatized with a guanidine functional group or any of the amine-functionalized nanoparticles referenced herein may further be derivatized with guanidine or a guanidine derivative.

Further suitable as the nitrogen component for interaction with the negatively charged cellulosic nanocrystals are quaternary amines. Such quaternary amines may be included in the fluid when pumped into the well. Suitable quaternary amines include the quaternized form of any of the nitrogen components referenced in the above paragraphs.

The amine functionalized nanoparticles referenced herein may be combined further with an amine compound/polymer. In an embodiment, the copolymer may comprise an acrylamide unit and a unit of the formula:

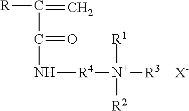

wherein R is methyl or hydrogen; R⁴ is a C₁ to C₆ alkyl group, optionally substituted with halogen, hydroxyl or an alkoxy (preferably methoxy and ethoxy) groups, X is halogen; and R¹, R² and R³ are independently selected from the group consisting of alkyl and alkoxy groups, preferably methyl, ethyl, methoxy and ethoxy. Further, suitable amine polymers include those formed via ring-forming polymerization of N,N-diallyl-N,N-di(C₁-C₄ alkyl)ammonium halide, comprising units of the formula:

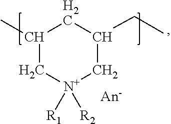

wherein R₁ and R₂ are each independently C₁-C₄ alkyl, in particular methyl, and An⁻ is an anion, for example, a halide anion such as the chloride anion.

In some instances, any of the negatively charged cellulosic nanocrystals referenced herein may be functionalized with a quaternary amine groups to form a positively charged nitrogen compound. Such a positively charged nitrogen compound may then, in turn, react with one or more negatively charged cellulosic nanocrystals. The formation of an exemplary quaternary amine functionalized cellulosic nanocrystals by treatment of the cellulosic nanocrystal with 2,3-epoxypropyl trimethyl ammonium chloride and sodium hydroxide may be represented by the equation:

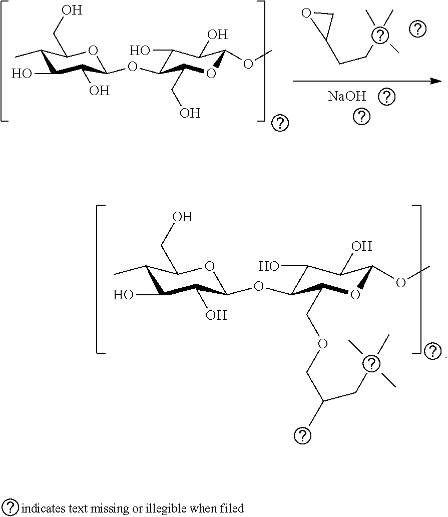

In an embodiment, the reactive nitrogen component may be a quaternary ammonium group.

In an embodiment, the proton for protonating the nitrogen component may be formed in-situ from a carbon dioxide pathway:

CO₂+H₂O⇄H₂CO₃ (A1)

H₂CO₃⇄HCO₃+H⁺ (B1)

As illustrated, the interaction of carbon dioxide produced (or pumped) downhole with water reversibly forms carbonic acid (A1) which in turn disassociates to produce the proton and bicarbonate (B1). Protonation of the nitrogen component and formation of the gel may proceed as follows:

H⁺+RNH₂⇄RNH₃⁺ (C1)

RNH₃⁺+CNC→Gel (D1)

In an alternative, the proton may originate from dissociation of water under acidic conditions or the proton may result from autoionization downhole. The generated proton may then react with the nitrogen component to form the protonated amine.

Exemplary of a generated proton interacting with a nitrogen containing component in-situ to form the protonated component may be represented as follows:

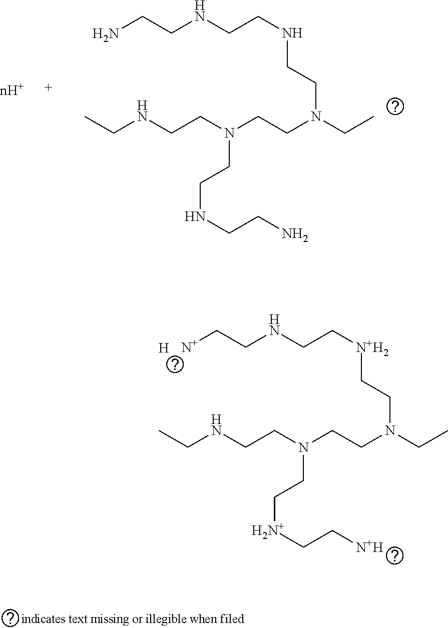

and the reaction of a protonated amine with CMC may be represented as follows:

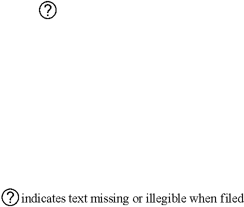

It is believed the particle attraction between the negatively charged CNC and the positively charged amine compound/polymer and/or amine-functionalized nanoparticles creates covalent linkages which create the stable gel. For example, the amino group of the positively charged amine compound/polymer and/or amine-functionalized nanoparticles may form a peptide bond (amide linkage) with the release of water molecule when reacted with a CNC having negatively charged carboxyl groups. Such interactions will form the crosslinked gel.

The protonated nitrogen component is generally formed downhole. However, in some instances, the protonated nitrogen component may be formed on the surface and then pumped into the well. In an exemplary embodiment, where the nitrogen component exhibits a pKa higher than 7 (such as aliphatic amines), the amine may protonated first and then pumped into the well in a fluid.

The degree of protonation of the amino containing component may be dependent on pH. In general the pH of the fluid defined herein is from about 4 to about 11. It has been observed that below a pH of about 11.6, more than 50% of tertiary amino groups are protonated and positively charged. The pH range narrows when the nitrogen containing component has only secondary or primary amine groups. Typically for secondary amines, the pH range narrows to from about 4 to about 6.7 and for primary amines from about 4 to about 4.5.

In an embodiment, the negatively charged component may be a carbamate formed in-situ. The carbamate may be formed from a variety of competitive pathways. Reaction of the carbamates and protonated nitrogen component forms a gel. In most cases, reaction products from carbamates generated in-situ strengthen the principal gel formed from the carbon dioxide pathway shown in (A1), (B1), (C1) and (D) above. Carbamates may affect the reactivity of dissolved carbon dioxide and may influence the mass transfer of gaseous carbon dioxide into the liquid phase downhole.

Carbamates may form, for example, from the reaction of carbon dioxide and (unprotonated) nitrogen component (A2):

CO₂+RNH₂⇄RNHCOO⁻+H⁺ (A2)

The released proton may be picked up by a second molecule of the amine compound to form protonated amine:

H⁺+RNH₂⇄RNH₃⁺ (C1)

Further, carbamates may form in-situ between the bicarbonate generated in-situ from carbon dioxide (B1) and (non-protonated)amine component:

HCO₃⁻+OH⁻⇄CO₃²⁻+H₂O (A3)

RNH₂+HCO₃⁻⇄RNHCOO⁻+H₂O (B2)

Reactions (A2) and (A3/B2) are essentially Lewis acid-base reactions where the unprotonated amine serves as the Lewis base and the carbon dioxide/carbonate is the Lewis acid. Any protonated amine generated in the fluid is not a Lewis base and thus will be non-reactive. In such cases, the sole reacting species is the free non-protonated amine with carbon dioxide/carbonate species which are Lewis acids.

Carbamate anions may also form from the carbonate form in (A1)/(B1).

In addition, a carbon salt, such as potassium carbonate, may be included in the fluid to be pumped. The carbonate ions may then form upon disassociation of the metal cations. For instance, where the carbonate salt is potassium carbonate, the carbonate may disassociate to form potassium cations and carbonate anion.

Further, when soluble carbonate salt is added to the pumpable fluid, the carbonate anion may capture a proton from the solution to form the bicarbonate anion. The bicarbonate can capture one more proton to form carbonic acid. Carbonic acid may then disintegrate, thereby forming carbon dioxide and water. All these species, (carbonate, bicarbonate, carbonic acid and carbon dioxide) may directly or through multiple steps interact with amino groups of the non-protonated amine containing compound to form carbamate anions. The carbamate anions may then form complexes with protonated amino groups on polymers and/or amino-functionalized nanoparticles to dynamically (non-covalently) crosslink them and thus contribute to gel formation with a negatively charged component. The function of the carbonate anion in this pathway is independent on the chemistry of the acidic groups on the negatively charged component.

Alternatively, the carbonate may originate from a calcium carbonate formation.

The carbamate may then react with the protonated amine component to form a gel:

H⁺+RNH₂⇄RNH₃⁺ (C1)

RNHCOO⁻+RNH₃⁺⁻⇄Gel (D2)

While formation of the gel between the protonated amine and negatively charged CNC may be the principal reaction to form the gel:

CO₂+H₂O⇄HₛCO₃ (A1)

H₂CO₃⇄HCO₃⁻+H⁺ (B1)

H⁺+RNH₂⇄RNH₃⁺ (C1)

RNH₃+CNC→Gel (D1)

the gel may optionally be hardened by the equilibria interactions of protonated amines and carbamate ions:

CO₂+RNH₂⇄RNHCOO⁻+H⁺ (A2)

RNH₂+HCO₃⁻⇄RNHCOO⁻+H₂O (B2)

RNH₂+H₂CO₃⇄RNHCOOH+H₂O (C3)

RNHCOOH+H₂O⇄RNHCOO⁻+H⁺ (C4)

HCO₃⁻+OH⁻⇄CO₃²⁻+H₂O (A3)

H⁺+RNH₂⇄RNH₃⁺ (C1)

RNHCOO⁻+RNH₃⁺⁻⇄Gel (D2)

As shown in A1-D1, the addition of carbon dioxide causes reaction with water to form carbonic acid which then dissociates to produce bicarbonate and the proton. The proton then protonates amino groups and the protonated amino groups, in turn, react with negatively charged cellulose. Carbon dioxide or its reaction products may further react and produce carbonic acid, bicarbonate and carbonate anions which may further react with amino groups to form carbamate anions (A2 and B2). The carbamate anions may form complexes with the protonated amino groups forming dynamic non-covalent links between amino groups of polymers or amino-functionalized nanoparticles or mixture thereof. In an embodiment, polymers containing protonated nitrogens and nanoparticles may form crosslinks which may, in turn, interact with negatively charged nanoparticles to form the gel.

The addition of soluble carbonate salt to the fluid typically increases the pH downhole since the carbonate anions capture protons to form the bicarbonate. Where the negatively charged component is functionalized cellulosic such as with carboxyl groups (such as carboxymethyl cellulose or cellulose prepared by TEMPO-mediated oxidation) or other weak acid groups, the increase in pH may cause additional deprotonation of the acidic groups on the cellulose. This deprotonation further decreases the charge of cellulose particles, while the released protons may further protonate amino groups on polymers and/or amino-functionalized nanoparticles. This increased “contrast” in distribution of positive and negative charges can further strengthen the gel.

In an embodiment, the aqueous fluid, prior to being gelled, may comprise between from about 2,000 to about 50,000 ppm of the negatively charged component by weight, more typically from about 10,000 to 30,000 ppm, more desirably between from about 12,000 to about 20,000 ppm.

The aqueous fluid is typically used in elevated temperature reservoirs. The fluid, when pumped into the well has a viscosity ranging less than 50 CP or even less than 15 cP. (Viscosity measurements referenced herein were made on a Malvern Kinexus Pro rotational rheometer at 100 sec-1 at 25 °C).

The aqueous fluid does not exhibit premature gelation when pumped downhole. Typically, the initial viscosity of the fluid remains ungelled for at least one hour at temperatures below 125 °C. In an embodiment, gelation does not occur until the temperatures in the well is from about 100 °C to about 140 °C. This is a significant advantage over fluids of the prior art where diversionary fluids tend to undergo gelation within minutes at temperatures higher than 90 °C.

The gelled plug may be reversed by purging with nitrogen gas, agitation, sonication or external stimulus changes, such as changes in pH, temperature or electric fields as well as internal and external breakers. As such, the broken gel can be more easily removed from the well during flowback. In some cases, the gel does not revert to a watery consistency until a period of over 7 days from the date the fluid was initially pumped into the reservoir.

After the formation is sealed with the gel plug, other treatment operations, such as the aforementioned acidizing operation, may be performed, when desired.

In an embodiment, the aqueous fluid is used to target selected zones in wells by remaining in a stable gel state at temperatures ranging from 200 to an excess of 250 °C, in some cases to an excess of 300 and in other cases as high as 350 °C as well as 500 °C for 24 to 48 hours. In most cases, the complete breakdown of the gel may not occur until about one week from the onset of breakdown. In an embodiment, the gel is capable of withstanding differential pressures of 800 psi (typically greater than 1,000 psi, often greater than 1,5000 psi or more) at such downhole temperatures. At such temperatures and pressures, the gel is stable for one hour, often eight hours, typically up to 48 hours and in some cases up to two weeks.

After being pumped into a reservoir, the fluid forms a stable fluid-impermeable gelled barrier or plug, i.e., a barrier or plug which isolates, substantially impairs or prevents the flow of fluids to locations where flow of fluids is not desirable, such as previously stimulated intervals.

The system has particular use in high pressure and/or elevated temperature wells, including geothermal wells as well as gas wells.

The system may be used in the treatment of carbonate formations such as limestone, chalk or dolomite (where the carbon dioxide may be produced in-situ) as well as sandstone or siliceous formations (where the carbon dioxide is pumped as a component of the fluid).

In a preferred embodiment, the well to which the fluid is introduced is a geothermal well. During geothermal well stimulation, the temporary blocking of high permeability zones is essential to direct injected acid selectively to the target formation.

In other embodiments, the fluid may be introduced to a gas or oil well. The wells may be completed gaping hole wells, with slotted or pre-perforated liners.

In an embodiment, the aqueous fluid may be pumped into a well as part of a stimulation operation, such as hydraulic fracturing, acid stimulation, steam injection and thermal injection. For instance, the gelled fluid may be introduced into the well subsequent to stimulation (hydraulic fracturing or acidizing). The gelled fluid forms a fluid barrier to one zone in the formation and subsequently introduced fluid is then diverted to one or other zones. In an embodiment, the gelled fluid forms a fluid permeable barrier to a high permeability (or non-damaged) zone such that subsequently pumped fluid is diverted to a zone of lower permeability. Since conductivity is permeability multiplied by injection geometry, this is synonymous to the statement that the gelled plug is capable of diverting a subsequently pumped fluid from a highly conductive primary fracture(s) to less conductive secondary fractures.

The aqueous fluid may also be used in the isolation of a productive zone in a well having multiple productive zones. After the formation is fractured to render a perforated productive zone, the aqueous fluid may then be introduced into the fractured perforated productive zone. The perforated productive zone may then be isolated by gelling the fluid. If desired, another productive zone of the well may be perforated and the process repeated.

In an embodiment, the aqueous fluid described herein may be introduced into a pre-determined targeted productive zone of a well containing multiple productive zones. The fluid in the pre-determined targeted productive zone may then be hardened, thereby isolating the pre-determined targeted productive zone from other zones in the well. The pre-determined targeted zone may then be perforated and subjected to hydraulic fracturing since the pre-determined targeted zone is sealed from other zones.

In an embodiment, the aqueous fluid may be employed in re-fracturing a selectively stimulated formation having a plurality of distinct production zones. Re-fracturing is often desirable when a production zone within the well may not have been adequately fractured. Even if the formation was adequately fractured, the production zone may no longer be producing at adequate levels. Over an extended period of time, the production from a previously fractured horizontal wellbore may decrease below a minimum threshold level. One technique to increase the hydrocarbon production is the addition of new fractures within the subterranean formation. During a re-fracturing operation, the aqueous fluid may be introduced into the zone to be re-fractured and the zone is then isolated by gelling the fluid.

The system may be used also as a diverter material introduced into coal beds having a series of natural fractures, or cleats, for the recovery of natural gases, such as methane.

The aqueous fluid may further be used as a fluid loss control additive in a drilling operation or completion operation. Loss of drilling mud into permeable zones of the formation or into the wellbore can dramatically increase costs by losing the fluid into the formation, damaging the drill bit caused by overheating, a decrease in the drilling rate or blowout due to a drop in fluid level in the well. In some instances, loss of mud and/or completion fluid into the formation and/or well may cause the collapse of the formation at the wellbore as well as in-depth plugging of the formation. This, in turn, may cause such extensive damage that the reservoir may have to be abandoned. Use of the aqueous fluid described herein may stop or retard the loss of drilling mud into the formation or wellbore by plugging the flow passages responsible for such losses. The aqueous fluid may act as a lost circulation material (LCM) by bridging or blocking seepage of the drilling mud into the formation. The aqueous fluid may be added to the drilling mud, for instance, as a fluid loss pill in order to reduce the loss of the mud into the porous permeable formation. Further, in those instances where fluid loss is detected during a drilling operation, pumping of the mud into the well may be halted and the aqueous fluid then pumped into the well to form a permeable plug in the targeted zone of the well where loss of mud into the formation or wellbore has been detected.

In an embodiment, the system finds applicability in the treatment of matrix formations having finer grained particles between larger rock particles or finer grained particles in which the larger particles are embedded. The formed gel reduces the influx of water into matrix formations characterized by low permeability. Further, matrix formations produce a large amount of water due to an influx of water into the wellbore. Over time, the amount or percentage of produced water may increase resulting in a corresponding decrease in the production of desired hydrocarbons, eventually rendering further production of hydrocarbons from the well uneconomical. The flow of water into the formation is blocked or otherwise abated by the gel. This results in increased rates in hydrocarbon production and ultimately increases recoverable reserves.

The system may further be used to store carbon dioxide in the well. This may be the case in those instances where the fluid pumped into the well contains carbon dioxide or where carbon dioxide is introduced into the well either before or after pumping of the aqueous fluid or is introduced into the well is pumped and wherein the amount of carbon dioxide is in excess of the stoichiometric amount needed to form the interactive proton. The excess amount of carbon dioxide may be released into the well upon reversal of the gel. Reversal of the gel may be effectuated by purging with nitrogen gas, agitation, sonication or external stimulus changes, such as changes in pH, temperature or electric fields.

Further, the aqueous fluid described herein may be used during a cementing operation where a cementitious slurry is pumped into the annulus between the exterior of the casing/liner (placed into the wellbore after drilling) and the wellbore. The cementitious slurry on hardening holds the casing/liner in place. Cementitious slurries may be used also to cement pipes or casings within water wells, injection wells, disposal wells and storage wells as well as in oil and gas wells. In addition to selectively isolating particular areas of the wellbore from other areas of the wellbore, cementitious slurries may further be used for other purposes. For instance, cements may be used during well abandonment such, e.g., in the sealing of the interior of the wellbore. In addition, cements may be used in remedial operations to repair casing and/or to achieve formation isolation as well as in sealing off perforations, repairing casing leak/s (including leaks from damaged areas of the casing), plugging back or sealing off the lower section of a wellbore, etc.

A widespread problem in well cementing is the loss of liquid fluid from the cementitious slurry into porous zones in the formation surrounding the well annulus. In addition, gas migration after placement of the cementitious slurry into the formation is problematic. Fluid (liquid and/or gas) loss is undesirable since it can result in dehydration of the cementitious slurry. In addition, it may cause the formation of thick filter cakes of cement solids. Such filter cakes may plug the wellbore. In addition, fluid loss can damage sensitive formations. Minimal fluid loss is desired therefore in order to provide better zonal isolation and to minimize formation damage by fluid invasion. The aqueous fluid serves as a LCM additive (including a gas control additives) for oil, gas and water wells. The aqueous fluid may be added to the cementitious slurry, for instance, as a fluid loss pill in order to reduce the loss of fluid (and gas migration) from the slurry to the porous permeable formation by forming the fluid impermeable plug. Further, in those instances where fluid loss is detected during a cementing operation, pumping of the cementitious slurry into the well may be halted and the aqueous fluid then pumped into the well to form a permeable plug in the targeted zone of the well where fluid loss has been detected.

Further, the system may be used to shut-off water and/or gas into a formation. In an embodiment, the gel plug causes reduction in permeability of the formation. Such decreased permeability stops or reduces the flow of aqueous liquids through the formation. The flow of unwanted water into the well is effectively reduced and the plug seals the formation porosity and permeability.

Preferred embodiments of the present disclosure thus offer advantages over the prior art and are well adapted to carry out one or more of the objects of this disclosure. However, the present disclosure does not require each of the components and acts described above and is in no way limited to the above-described embodiments or methods of operation. Any one or more of the above components, features and processes may be employed in any suitable configuration without inclusion of other such components, features and processes. Moreover, the present disclosure includes additional features, capabilities, functions, methods, uses and applications that have not been specifically addressed herein but are, or will become, apparent from the description herein, the appended drawings and claims.

All percentages set forth in the Examples are given in terms of weight units except as may otherwise be indicated.

### EXAMPLES

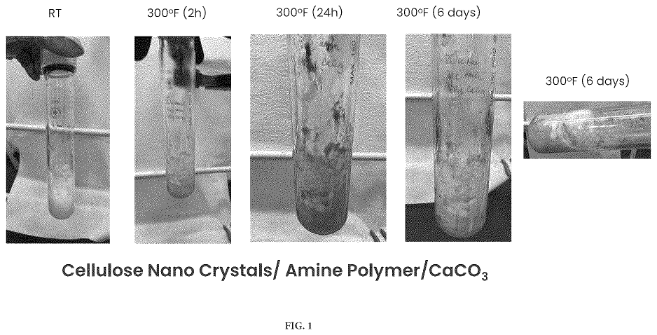

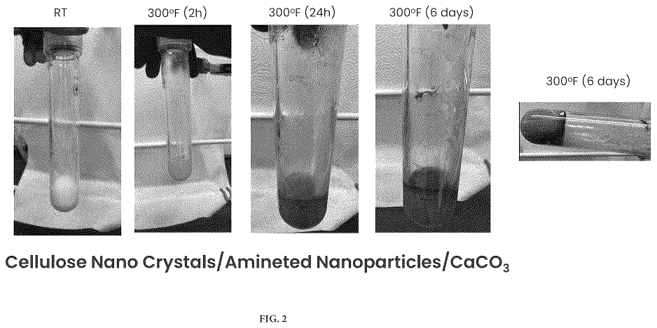

Example 1. An aqueous system containing native cellulose was treated with sulfuric acid under controlled conditions from room temperature to 70 °C while stirring at 200 rpm for a period of 3 hours. The resulting suspension was then diluted with water and centrifuged. Free acids present in the suspension were removed by dialysis with distilled water. The presence of the sulfate groups on the resulting nanocrystals increased the water dispersibility and provided a stable colloidal suspension. The resulting nanocrystals were then treated with a poly(diallyldimethylammonium chloride) of approximately 20 wt. % in water in the presence of carbon dioxide. The stability of the gel was determined by observing the gel strength over a period of six days at a temperature from room temperature to 300 °F. The results are illustrated in FIG. 1.
Example 2. The protocol of Example 1 was repeated except an aminated nanoparticles were used in place of the polyamino compound. The results are illustrated in FIG. 2.
Embodiment 1. A method of enhancing productivity from a subterranean formation penetrated by a well comprising:
(a) forming a gel in-situ from:
   (i) negatively charged cellulosic nanocrystals; and
   (ii) a positively charged nitrogen reactant selected from the group consisting of quaternary amine compounds and protonated nitrogen compounds of amine compounds, amine polymers, amine functionalized nanoparticles and mixtures thereof; and
(b) forming a fluid impermeable barrier from the gel.
Embodiment 2. A method of enhancing productivity from a subterranean formation penetrated by a well comprising:
(a) introducing into the well an aqueous fluid comprising:
   (i) negatively charged cellulosic nanocrystals; and
   (ii) a nitrogen component selected from the group consisting of amine compound, amine polymer, amine functionalized nanoparticles and mixtures thereof;
(b) protonating the nitrogen component; and
(c) forming a fluid impermeable barrier in-situ by reacting the negatively charged cellulosic nanocrystals with the protonated nitrogen component.
Embodiment 3. The method of embodiment 1 or 2, further comprising generating a carbamate in-situ and strengthening the gel of the impermeable barrier with a gel formed from protonated nitrogen component and carbamate.
Embodiment 4. The method of any of embodiments 1 to 3, wherein the fluid impermeable barrier is formed in a targeted zone within the formation.
Embodiment 5. The method of any of embodiments 1 to 4, further comprising:
(d) pumping one or more second fluids into the well; and
(e) diverting flow of the one or more second fluids from the targeted zone to one or more second zones, wherein permeability of the targeted zone is higher than the permeability of the one or more second zones.
Embodiment 6. The method of any of embodiments 1 to 5, wherein either:
(i) the aqueous fluid further comprises carbon dioxide;
(ii) carbon dioxide is introduced into the well with the aqueous fluid; or
(iii) carbon dioxide is introduced into the well after pumping the aqueous fluid into the well
   and further wherein the carbon dioxide triggers the gelation of the fluid.
Embodiment 7. A method of stimulating a subterranean formation penetrated by a well, the method comprising:
(a) introducing into the well an aqueous first fluid comprising:
   (i) negatively charged cellulosic nanocrystals;
   (ii) a quaternary amine or a nitrogen containing component which, when protonated, is reactive with the negatively charged cellulosic nanocrystals; and
   (iii) water;
(b) gelling the aqueous first fluid and forming a plug in a targeted zone within the formation wherein the plug constitutes a fluid impermeable barrier;
(c) pumping one or more aqueous second fluids into the well; and
(d) diverting flow of the one or more aqueous second fluids from the targeted zone to one or more second zones, wherein permeability of the targeted zone is higher than the permeability of the one or more second zones.
Embodiment 8. The method of embodiment 7, further comprising reacting the negatively charged cellulosic nanoparticles with the quaternary amine or protonated nitrogen component to form the fluid impermeable barrier.
Embodiment 9. A method of enhancing productivity from a subterranean formation penetrated by a well, the method comprising:
(A) introducing into the well an aqueous first fluid comprising:
   (a) negatively charged cellulosic nanocrystals selected from the group consisting of (i) carboxymethyl cellulosic nanocrystals; (ii) nanocrystals surface modified with hydroxyl, sulfonate and/or phosphate groups; (iii) nanocrystals surface modified with quaternary amine groups; or (iv) oxidized cellulosic nanocrystals;
   (b) a nitrogen containing component selected from the group consisting of amine compound nanoparticles, polyamino nanoparticles, or amine functionalized nanoparticles or a mixture thereof; and
   (c) water;
(B) forming a protonated nitrogen component salt from the proton and nitrogen containing component;
(C) reacting the protonated salt with the negatively charged cellulosic nanocrystals;
(D) gelling the reaction product of (C) to form a plug wherein the plug constitutes an impermeable barrier to fluid flow; and
(E) impairing or preventing flow of subsequently introduced fluids into an area sealed by the plug.
Embodiment 10. The method of any of embodiments 1 to 9, wherein the subterranean formation is a carbonate or sandstone formation.
Embodiment 11. The method of any of embodiments 1 to 10, wherein the well is a geothermal well.
Embodiment 12. The method of any of embodiments 1 to 11, wherein the negatively charged cellulosic nanocrystals are carboxymethyl cellulose nanocrystals.
Embodiment 13. The method of any of embodiments 1 to 11, wherein the negatively charged nanocrystals are native cellulosic fibers derivatized by acid hydrolysis.
Embodiment 14. The method of embodiment 13, wherein the negatively charged nanocrystals are surface modified with hydroxyl, sulfonate and/or phosphate groups.
Embodiment 15. The method of any of embodiments 1 to 11, wherein the negatively charged nanocrystals are quaternary amine functionalized cellulosic nanocrystals, oxidized cellulosic nanocrystals or a combination thereof.
Embodiment 16. The method of any of embodiments 1 to 11, wherein the negatively charged nanocrystals are cellulosic nanocrystals modified by treatment with 2,3-epoxypropyl trimethyl ammonium chloride and sodium hydroxide.
Embodiment 17. The method of any of embodiments 1 to 11, wherein the negatively charged nanocrystals are cellulosic nanocrystals modified by treatment with 2,2,6,6-tetramethylpiperidin-1-yl oxyl with sodium hydroxide and sodium chlorate.
Embodiment 18. The method of embodiment 11, wherein the negatively charged nanocrystals are nanocrystals modified with sulfate half-ester groups.
Embodiment 19. The method of any of embodiments 1 to 18, further comprising removing the fluid impermeable barrier from the well by at least one of the following:
(a) pumping nitrogen gas into the well;
(b) subjecting the fluid impermeable barrier to sonication or agitation; or
(c) introducing a fluid into the well and modifying the pH of the impermeable barrier.
Embodiment 20. The method of any of embodiments 1 to 19, wherein the nitrogen containing component is selected from the group consisting of imidazole, ethanolamine, isopropylamine, triethylamine, diisopropylamine, dipropylamine, N,N-diisopropyethylamine, trimethylamine hydrochloride, methylamine hydrochloride, n-hexylamine, n-octylamine, n-hexyldecylamine, oleylamine, 4-aminophenol, 1,2-phenylenediamine, 1,4-phenylenediamine, N,N,N′,N′,N″-pentamethyldiethylenetriamine, N,N,N′,N′-tetramethylethylenediamine, ethylene diamine, bis(3-aminopropyl)amine, 1,3-diaminopropane, hexamethylenediamine, polyvinyl amines, polylysine, poly(L-lysine hydrobromide), poly(N-isopropylacrylanide), chitosan, poly(4-aminosytrene), poly(N-methylvinylamine), poly(ethylene glycol)bis(2-aminoethyl), poly(2-vinyl-1-methylpyridinium bromide), poly(vinylamine) hydrochloride, polyethyleneimine, polyallylamines, polyethylene amines, polyethylene glycol amines, polyether amines, polyamine compounds of the formula H₂NCH₂[(CH₂)ₙNH]ₘCH₂NH₂ wherein n and m are independently selected from 2 to 24, epoxidized amines containing three to six carbon atoms, polyethyleneimine, poly(allylamine hydrochloride), poly(allylamine), poly(diallylmethyl ammonium chloride), as well as copolymers of an acrylamide unit and a diallyldimethylammonium salt and, optionally, an acrylic acid or a salt thereof, or a nanoparticle having one or more amine groups.
Embodiment 21. The method of embodiment 20, wherein the nitrogen containing component is further functionalized with a guanidine or guanidine derivative.
Embodiment 22. The method of any of embodiments 1 to 19, wherein the nitrogen containing component is guanidine or a derivative thereof.

1. A method of enhancing productivity from a subterranean formation penetrated by a well comprising:
(a) forming a gel in-situ from an aqueous first fluid comprising:
(i) negatively charged cellulosic nanocrystals; and
(ii) a positively charged nitrogen reactant selected from the group consisting of quaternary amine compounds and protonated nitrogen compounds of amine compounds, amine polymers, amine functionalized nanoparticles and mixtures thereof; and
(b) forming a fluid impermeable barrier from the gel.

2. The method of claim 1, further comprising generating a carbamate in-situ and strengthening the gel of the impermeable barrier with a gel formed from protonated nitrogen component and carbamate.

3. The method of claim 1, further comprising:
(c) pumping one or more second fluids into the well; and
(d) diverting flow of the one or more second fluids from the targeted zone to one or more second zones, wherein permeability of the targeted zone is higher than the permeability of the one or more second zones.

4. The method of claim 1, wherein either:
(i) the aqueous fluid further comprises carbon dioxide;
(ii) carbon dioxide is introduced into the well with the aqueous fluid; or
(iii) carbon dioxide is introduced into the well after pumping the aqueous fluid into the well
and further wherein the carbon dioxide triggers the gelation of the fluid.

5. The method of claim 1, wherein the negatively charged cellulosic nanocrystals are selected from the group consisting of (i) anionic carboxymethyl cellulose nanocrystals; (ii) anionic nanocrystals modified with sulfate half-ester groups; (iii) native cellulosic fibers derivatized by acid hydrolysis; (iv) negatively charged nanocrystals surface modified with hydroxyl, sulfonate and/or phosphate groups; and (v) mixtures thereof.

6. The method of claim 1, wherein the subterranean formation is a carbonate or sandstone formation.

7. The method of claim 1, wherein the well is a geothermal well.

8. The method of claim 1, wherein the positively charged nitrogen reactant are nanoparticles functionalized with an amine or amino group.

9. The method of claim 8, wherein the nanoparticles are selected from the group consisting of nanotubes, nanographite, nanodots, nanorods, nanodiamonds, fullerenes, graphenes and mixtures thereof.

10. The method of claim 1, wherein the amine compounds and amine polymers are selected from the group consisting of ethanolamine, isopropylamine, triethylamine, diethylamine, diisopropylamine, dipropylamine, N,N-diisopropyethylamine, trimethylamine hydrochloride, methylamine hydrochloride, n-hexylamine, n-octylamine, n-hexyldecylamine, oleylamine, 4-aminophenol, 1,2-phenylenediamine, 1,4-phenylenediamine, N,N,N′,N′,N″-pentamethyldiethylenetriamine, N,N,N′N′tetramethylethylenediamine, ethylene diamine, bis(3-aminopropyl)amine, 1,3-diaminopropane, hexamethylenediamine, polyvinyl amines, polylysine, poly(L-lysine hydrobromide), poly(N-isopropylacrylamide), chitosan, poly(4-aminosytrene), poly(N-methylvinylamine), poly(ethylene glycol)bis(2-aminoethyl), poly(2-vinyl-1-methylpyridinium bromide), poly(vinylamine) hydrochloride, polyethyleneimine, polyallylamines, polyethylene amines, polyethylene glycol amines, polyether amines, polyamine compounds of the formula H₂NCH₂[(CH₂)ₙNH]ₘCH₂NH₂ wherein n and m are independently selected from 2 to 24, epoxidized amines containing three to six carbon atoms, poly(allylamine hydrochloride), poly(allylamine), poly(diallylmethyl ammonium chloride), as well as copolymers of an acrylamide unit and a diallyldimethylammonium salt and, optionally, an acrylic acid or a salt thereof.

11. The method of claim 1, further comprising removing the fluid impermeable barrier from the well by at least one of the following:
(i) pumping nitrogen gas into the well;
(ii) subjecting the fluid impermeable barrier to sonication or agitation; or
(iii) introducing a fluid into the well and modifying the pH of the impermeable barrier.

12. The method of claim 1, wherein the nitrogen containing component is further functionalized with a guanidine or guanidine derivative.

13. The method of claim 1, wherein the nitrogen containing component is guanidine or a derivative thereof.

14. A method of stimulating a subterranean formation penetrated by a well, the method comprising:
(a) introducing into the well an aqueous first fluid comprising:
(i) negatively charged cellulosic nanocrystals;
(ii) a quaternary amine or a nitrogen containing component which, when protonated, is reactive with the negatively charged cellulosic nanocrystals; and
(iii) water;
(b) gelling the aqueous first fluid and forming a plug in a targeted zone within the formation wherein the plug constitutes a fluid impermeable barrier;
(c) pumping one or more aqueous second fluids into the well; and
(d) diverting flow of the one or more aqueous second fluids from the targeted zone to one or more second zones, wherein permeability of the targeted zone is higher than the permeability of the one or more second zones.

15. The method of claim 14, further comprising reacting the negatively charged cellulosic nanoparticles with the quaternary amine or protonated nitrogen component to form the fluid impermeable barrier.

16. The method of claim 14, wherein at least one of the following prevails:
(a) the negatively charged cellulosic nanocrystals are selected from the group consisting of (i) anionic carboxymethyl cellulose nanocrystals; (ii) anionic nanocrystals modified with sulfate half-ester groups; (iii) native cellulosic fibers derivatized by acid hydrolysis; (iv) negatively charged nanocrystals surface modified with hydroxyl, sulfonate and/or phosphate groups; and (v) mixtures thereof;
(b) the subterranean formation is a carbonate or sandstone formation or the well is a geothermal well;
(c) the positively charged nitrogen reactant are nanoparticles functionalized with an amine or amino group:
(d) the nanoparticles are selected from the group consisting of nanotubes, nanographite, nanodots, nanorods, nanodiamonds, fullerenes, graphenes and mixtures thereof,
(e) the amine compounds and amine polymers are selected from the group consisting of ethanolamine, isopropylamine, triethylamine, diethylamine, diisopropylamine, dipropylamine, N,N-diisopropyethylamine, trimethylamine hydrochloride, methylamine hydrochloride, n-hexylamine, n-octylamine, n-hexyldecylamine, oleylamine, 4-aminophenol, 1,2-phenylenediamine, 1,4-phenylenediamine, N,N,N′,N′,N″-pentamethyldiethylenetriamine, N,N,N′,N′-tetramethylethylenediamine, ethylene diamine, bis(3-aminopropyl)amine, 1,3-diaminopropane, hexamethylenediamine, polyvinyl amines, polylysine, poly(L-lysine hydrobromide), poly(N-isopropylacrylanide), chitosan, poly(4-aminosytrene), poly(N-methylvinylamine), poly(ethylene glycol)bis(2-aminoethyl), poly(2-vinyl-1-methylpyridinium bromide), poly(vinylamine) hydrochloride, polyethyleneimine, polyallylamines, polyethylene amines, polyethylene glycol amines, polyether amines, polyamine compounds of the formula H₂NCH₂[(CH₂)ₙNH]ₘCH₂NH₂ wherein n and m are independently selected from 2 to 24, epoxidized amines containing three to six carbon atoms, polyethyleneimine, poly(allylamine hydrochloride), poly(allylamine), poly(diallylmethyl ammonium chloride), as well as copolymers of an acrylamide unit and a diallyldimethylammonium salt and, optionally, an acrylic acid or a salt thereof,
(f) the nitrogen containing component is further functionalized with a guanidine or guanidine derivative; or
(g) the nitrogen containing component is guanidine or a derivative thereof.

17. A method of enhancing productivity from a subterranean formation penetrated by a well, the method comprising:
(A) introducing into the well an aqueous first fluid comprising:
(a) negatively charged cellulosic nanocrystals selected from the group consisting of (i) carboxymethyl cellulosic nanocrystals; (ii) nanocrystals surface modified with hydroxyl, sulfonate and/or phosphate groups; (iii) nanocrystals surface modified with quaternary amine groups; or (iv) oxidized cellulosic nanocrystals;
(b) a nitrogen containing component selected from the group consisting of amine compound nanoparticles, polyamino nanoparticles, or amine functionalized nanoparticles or a mixture thereof; and
(c) water;
(B) forming a protonated nitrogen component salt from the proton and nitrogen containing component;
(C) reacting the protonated salt with the negatively charged cellulosic nanocrystals;
(D) gelling the reaction product of (C) to form a plug wherein the plug constitutes an impermeable barrier to fluid flow; and
(E) prohibiting fluid of subsequently introduced fluids with the formed plug.

18. The method of claim 17, wherein the fluid impermeable barrier is formed in a stimulation, refracturing, drilling, completion, workover or cementing operation.

19. The method of claim 17, wherein at least one of the following prevails:
(a) the negatively charged cellulosic nanocrystals are selected from the group consisting of (i) anionic carboxymethyl cellulose nanocrystals; (ii) anionic nanocrystals modified with sulfate half-ester groups; (iii) native cellulosic fibers derivatized by acid hydrolysis; (iv) negatively charged nanocrystals surface modified with hydroxyl, sulfonate and/or phosphate groups; and (v) mixtures thereof;
(b) the positively charged nitrogen reactant are nanoparticles functionalized with an amine or amino group;
(c) the nanoparticles are selected from the group consisting of nanotubes, nanographite, nanodots, nanorods, nanodiamonds, fullerenes, graphenes and mixtures thereof;
(d) the amine compounds and amine polymers are selected from the group consisting of ethanolamine, isopropylamine, triethylamine, diethylamine, diisopropylamine, dipropylamine, N,N-diisopropyethylamine, trimethylamine hydrochloride, methylamine hydrochloride, n-hexylamine, n-octylamine, n-hexyldecylamine, oleylamine, 4-aminophenol, 1,2-phenylenediamine, 1,4-phenylenediamine, N,N,N′,N′,N″-pentamethyldiethylenetriamine, N,N,N′,N′-tetramethylethylenediamine, ethylene diamine, bis(3-aminopropyl)amine, 1,3-diaminopropane, hexamethylenediamine, polyvinyl amines, polylysine, poly(L-lysine hydrobromide), poly(N-isopropylacrylanide), chitosan, poly(4-aminosytrene), poly(N-methylvinylamine), poly(ethylene glycol)bis(2-aminoethyl), poly(2-vinyl-1-methylpyridinium bromide), poly(vinylamine) hydrochloride, polyethyleneimine, polyallylamines, polyethylene amines, polyethylene glycol amines, polyether amines, polyamine compounds of the formula H₂NCH₂[(CH₂)ₙNH]ₘCH₂NH₂ wherein n and m are independently selected from 2 to 24, epoxidized amines containing three to six carbon atoms, polyethyleneimine, poly(allylamine hydrochloride), poly(allylamine), poly(diallylmethyl ammonium chloride), as well as copolymers of an acrylamide unit and a diallyldimethylammonium salt and, optionally, an acrylic acid or a salt thereof;
(e) the nitrogen containing component is further functionalized with a guanidine or guanidine derivative; or
(f) the nitrogen containing component is guanidine or a derivative thereof.

20. The method of claim 17, wherein either the subterranean formation is a carbonate or a sandstone formation or the well is a geothermal well.
